(19) United States
(12) Patent Application Publication
(10) Pub. No.: US 2020/0384809 A1
(43) Pub. Date: Dec. 10, 2020

(54) Reinforcement Layer and Pneumatic Vehicle Tire

(71) Applicant: Continental Reifen Deutschland GmbH, Hannover (DE)

(72) Inventors: Wolfgang Reese, Peine (DE); Michael Schunack, Hannover (DE)

(73) Assignee: Continental Reifen Deutschland GmbH, Hannover (DE)

(21) Appl. No.: 16/772,552

(22) PCT Filed: Sep. 25, 2018
(86) PCT No.: PCT/EP2018/075875

§ 371 Date: Jun. 12, 2020

(30) Foreign Application Priority Data
Dec. 13, 2017 (DE) 10 2017 222 606.4

(51) Int. Cl. B60C 9/00; B60C 9/20; D02G 3/48; D02G 3/04; D02G 3/28

(52) U.S. Cl. CPC B60C 9/005; B60C 9/0042; B60C 9/20; D02G 3/48; B60C 2009/2257; D02G 3/28; B60C 2009/0092; B60C 2009/2077; B60C 2009/2083; D02G 3/045

(57) ABSTRACT

The invention relates to a reinforcement layer for elastomeric products, in particular for the belt bandage (8), having cords as reinforcement, where the cords have at least two yarns, where a first yarn of the yarns is made of polyamide and where the ends of all yarns of a cord are twisted together. The problem addressed by the invention is that of providing a reinforcement layer for elastomeric products which exhibits a relatively high tensile force value for an elongation of 4% or more and which exhibits relatively low shrinkage based on linear density of the reinforcement. This is achieved in that the cords are hybrid cords having precisely three yarns, in that the hybrid cord has the first yarn and a second yarn made of HMLS-PET, in that the hybrid cord has a first yarn or a second yarn as third yarn, and in that the linear density of each hybrid cord is at least 5000 dtex.

The invention relates to a reinforcement layer for elastomeric products, where the reinforcement layer has cords as reinforcement which are arranged within the layer in essence parallel to one another and are embedded into elastomeric material, where the cords have at least two yarns, where a first yarn of the yarns is made of polyamide and where the ends of all yarns of a cord are twisted together. The invention further relates to a pneumatic tire which comprises at least one reinforcement layer of the invention.

Reinforcement elements for reinforcing various elastomeric products are well known. It is therefore known that pneumatic tires can use a belt bandage which is configured with one or more layers and which covers the belt edges and in essence comprises reinforcement taking the form of cords which are embedded in rubber and which in essence run in circumferential direction. This belt bandage serves, in particular in high-speed use, to prevent upward movement of the tire as a result of the centrifugal forces arising when a vehicle is in motion.

During tire production, the bandage is applied in the form of layers, strips or individual cords with reinforcement elements embedded into an unvulcanized rubber mixture, these elements being wound or coiled onto the belt. In the procedure for embedding the reinforcement elements in rubber, an array of reinforcement elements which are in essence parallel and take the form of threads, and which generally have been subjected to thermal pretreatment and/or to pretreatment with an impregnation system for improving adhesion to the embedding rubber in the manner known to the person skilled in the art are passed in longitudinal direction through a calender or an extruder for achieving sheathing with the rubber mixture.

When shaping is carried out with the use of devices used hitherto, and when the tire is vulcanized, the upward movement generally causes up to 2% expansion in the shoulder region and up to 4% expansion in the central region when comparison is made to unvulcanized green tire, when the green tire is wound on a flat drum. Requirements placed upon more modern construction drums during production of tires for ultrahigh-speed use are about 1% expansion in the shoulder and about 3% expansion in the crown region. A further problem consists in the shrinkage behavior of the respective cord material at elevated temperature. Low shrinkage behavior results in relatively high dimensional stability of the tire and therefore better flatspot behavior, this being an expression known to the person skilled in the art (=reversible plastic flattening effects in the area in contact with the ground when a vehicle is stationary).

During tire production, the cords of the bandage are intended to permit sufficient upward movement during shaping and in the vulcanization mold, in order that precise shaping of the tire can be achieved, and after tire manufacture they are intended to ensure good functionality at high speed when a vehicle is in motion, i.e. to ensure good dimensional stability. In order to comply with these requirements, the cords should be amenable to elongation up to an elongation of about 3 to 4% when subjected to moderate force and then to greater elongation only when very large force is applied.

The bead reinforcement is arranged entirely or to some extent in the bead region. It is usually axially outside and connected to the carcass. The bead reinforcement comprises at least one reinforcement layer which runs around the tire in circular form in the region of the bead.

Conveyor belts, drive belts, hoses and air-spring bellows also require the use of reinforcement elements with physical properties matched to the requirements.

U.S. Pat. No. 7,252,129 B2 discloses a hybrid cord consisting of aramid fibers and of a further fiber selected from the group consisting of polyester, nylon and rayon. This hybrid cord ensures relatively small separation of the individual threads of the reinforcement layer. Aramid has the disadvantage of comparatively low elongation at break and of high purchase cost.

WO 2014/001039 A1 discloses a single-layer belt bandage of a pneumatic tire where the reinforcement elements of the belt bandage are hybrid cords with the structure polyamide 6.6 940×1+HMLS-PET 1100×1. Although this type of belt bandage exhibits advantageous force/elongation behavior, the tensile force value for this type of belt bandage for elongation of 4% or more for ultrahigh-speed use is too small to provide adequate concentration of the centrifugal forces arising during ultrahigh-speed use.

In a known method of providing an adequate concentration of the centrifugal forces arising during ultrahigh-speed use, the belt bandage is equipped with two reinforcement layers. The reinforcement elements of each reinforcement layer here are cords made of two polyamide 6.6 yarns of linear density 1400 dtex, the ends of which are twisted together. The cords are arranged with a thread density of 110 epdm within the respective reinforcement layer. However, it is disadvantageous that the known belt bandage made of two reinforcement layers uses a large quantity of elastomeric material that is disadvantageous for rolling resistance. The polyamide 6.6 cords moreover exhibit disadvantageous shrinkage behavior, with resultant impairment of the dimensional stability and of flatspot behavior.

One of the problems addressed by the invention then consists in provision of a reinforcement layer for elastomeric products which exhibits a relatively high tensile force value for elongation of 4% or more and which exhibits relatively low shrinkage based on linear density of the reinforcement.

The problem is solved in the invention in that the cords are hybrid cords, in that each of the hybrid cords has precisely three yarns, in that the three yarns are composed of the first yarn made of polyamide, a second yarn made of high-modulus low-shrinkage polyethylene terephthalate (HMLS-PET) and a third yarn, in that the third yarn is configured as first yarn or as second yarn and in that the linear density of each hybrid cord is at least 5000 dtex.

A further problem addressed by the invention consists in provision of a pneumatic tire which exhibits relatively low rolling resistance, and also relatively low shrinkage.

This problem is solved in that the pneumatic tire comprises an inventive reinforcement layer for elastomeric products.

For the process of the present invention, cords are linear constructs which consist of two or more yarns twisted together. A hybrid cord is a cord in which at least two yarns differ in their material. For the purposes of the present invention, a yarn is a linear construct as described in DIN 60900, consisting of individual filaments or fibers. For the purposes of the invention, the expressions yarn made of polyester and polyester yarn, and also yarn made of polyamide and polyamide yarn, are used synonymously. A yarn made of a material is composed entirely or to some extent of said material.

Force/elongation values and/or the tensile force value for a given elongation can be determined in accordance with ASTM D885.

The hybrid cords of the reinforcement layer of the invention have precisely three yarns, the ends of which are twisted together. The three yarns here are the first yarn made of polyamide, the second yarn made of HMLS-PET and the third yarn, which is configured as first yarn or as second yarn. The hybrid cord therefore has an asymmetric structure and has either two first yarns made of polyamide and one second yarn made of HMLS-PET or a first yarn made of polyamide and two second yarns made of HMLS-PET.

Surprisingly, it has been found that this type of reinforcement layer having these asymmetric hybrid cords features a significantly increased tensile force value for the reinforcement layer for elongation of 4% or more, and also features lower shrinkage based on linear density of the reinforcement.

Very surprisingly, the reinforcement layer with the asymmetric hybrid cords having not only at least one yarn made of polyamide but also at least one yarn made of HMLS-PET exhibits greatly improved properties in respect of tensile force. Very surprisingly, the hybrid cords exhibit force/elongation behavior that has excellent suitability for the use in a reinforcement layer of the belt bandage.

The linear density of hybrid cords is at least 5000 dtex. Very surprisingly, it has been found that a single reinforcement layer of the invention with hybrid cords of this linear density has sufficient strength to replace, for example in the belt bandage of a pneumatic tire, two of the reinforcement layers described made of cords made in each case of two polyamide 6.6 yarns. A lower linear density would no longer provide adequate strength. The replacement of two reinforcement layers by only one reinforcement layer leads to a significant reduction in terms of weight and in terms of material, in particular in terms of elastomeric material, and therefore to an advantageous reduction of rolling resistance.

By virtue of the significantly improved tensile force value for the reinforcement layer it is therefore possible to use only one layer in the design of the belt bandage, even in the case of tires for ultrahigh-speed use. The reinforcement layer of the invention is therefore configured as single reinforcement layer of the belt bandage.

The hybrid cord made of at least one polyamide yarn and of at least one PET yarn has lower relative polyamide content than a comparative cord made only of polyamide yarns. HMLS-PET exhibits advantageous lower shrinkage than polyamide. A reduction has therefore been achieved in the shrinkage of the reinforcement, based on linear density. These yarns made of HMLS-PET have good thermal stability and therefore comply with requirements in the uses mentioned, for example functionality at ultrahigh speed in the use in the pneumatic tire.

A pneumatic tire comprising a reinforcement layer of the invention in at least one component exhibits increased dimensional stability and particularly good ultrahigh-speed functionality. Flattening effects under load (flatspotting) are reduced. It is preferable that the reinforcement layer of the invention is configured as belt bandage in order to achieve the advantages mentioned. Rolling resistance is moreover reduced.

The polyamide of the first polyamide yarn is selected from the group consisting of polyamide 6 (PA 6) and/or polyamide 6.6 (PA 6.6) and/or polyamide 12 (PA 12) and/or polyamide 11 (PA 11) and/or polyamide 13.13 (PA 13.13) and/or polyamide 4 (PA 4) and/or polyamide 7 (PA 7) and/or polyamide 8 (PA 8) and/or polyamide 9 (PA 9) and/or polyamide 4.6 (PA 4.6) and/or polyamide 6.10 (PA 6.10) and/or polyamide 6.12 (PA 6.12) and/or polyamide 6.9 (PA 6.9) and/or polyamide 66/6 (PA 66/6).

Preference is given to use of PA 6 and/or PA 6.6, and particular preference is given to use of PA 6.6.

A yarn made of PA 6.6 has advantageous good adhesion for incorporation into the elastomeric material, and also has excellent suitability in respect of its modulus of elasticity for the use as reinforcement of a belt bandage. At the same time, it has good market availability and low purchase cost.

In a preferred embodiment, precisely two yarns of the hybrid cord are configured identically in respect of their material and their linear density. The hybrid cord therefore has either two yarns made of a polyamide, preferably of PA 6.6, of the same linear density, or two yarns made of HMLS-PET of identical linear density. The complexity of the hybrid cord is thus reduced in respect of its structure and of its production.

The respective linear density of each of the three yarns of the hybrid cord is advantageously 1000 dtex to 3000 dtex, preferably 1000 dtex to 2500 dtex, particularly preferably 1500 dtex to 2200 dtex. At a linear density lower than 1000 dtex, the hybrid cord made of precisely three yarns would then lack strength. A linear density greater than 3000 dtex for the yarns has attendant disadvantages resulting from an unnecessarily large quantity of material, e.g. disadvantages in rolling resistance in the use in the pneumatic tire. Very surprisingly, a linear density of at most 2500 dtex, sometimes even at most 2200 dtex, is already adequate to reach an advantageous force/elongation behavior of the hybrid cord.

Each yarn of the reinforcement layer of the invention can be twisted in S direction or in Z direction. The three yarns for hybrid cords advantageously have the same twist direction. They are therefore either all twisted in S direction and/or in Z direction.

The ends of the three yarns in the invention are twisted together in S direction or in Z direction to give a hybrid cord. The direction of twist to give the hybrid cord is advantageously opposite to the twist direction of the yarns. Internal stresses in the hybrid cord are thus reduced.

In one embodiment, the hybrid cords are arranged with a thread density of 50 epdm to 90 epdm, preferably 60 epdm to 80 epdm, within the reinforcement layer. This low density already ensures an adequate tensile force in the use in the pneumatic tire, in particular for concentrating, in the form of a single-layer belt bandage, the centrifugal forces arising during ultrahigh-speed use. This relatively low thread density is advantageous because the durability of the reinforcement layer and, respectively, of the elastomer product is increased as a result of lower rubberization shear stresses.

In an advantageous reinforcement layer of the invention, the hybrid cords have the structure polyamide 6.6 2100×2+HMLS-PET 2200×1 and are arranged with a thread density of 70 epdm to 90 epdm within the reinforcement layer. This type of reinforcement layer exhibits advantageous force/elongation behavior for the use as single reinforcement layer of the belt bandage, together with high tensile force value and low shrinkage. Rolling resistances moreover reduce when comparison is made with a two-layer structure. Thread density is advantageously 80 epdm.

Corresponding advantages are obtained when the hybrid cords have the structure polyamide 6.6 2100×1+HMLS-PET 2200×2 and are arranged with a thread density of 50 epdm to 70 epdm within the reinforcement layer. The further reduction of thread density provides further advantages in the durability of the reinforcement layer. The thread density is advantageously 60 epdm. At the same time, the structure made of a first polyamide yarn and of two second yarns made of HMLS-PET further reduces the quantity of polyamide 6.6. This type of reinforcement layer exhibits a further improvement in thermal stability.

Reliable adhesion of textile reinforcement elements to the rubber is advantageously ensured in that an adhesive impregnation system for ensuring adhesion of the reinforcement elements to the rubber is provided for the hybrid cords. An RFL dip can be used by way of example in the single- or double-bath process to apply the said adhesive impregnation system. However, it is also possible to achieve impregnation by using any of the other processes and adhesives known to a person skilled in the art.

If the reinforcement layer relates to a belt bandage, this is configured at an angle of between 0° and 5° to the circumferential direction, in the form of a single layer or of multiple layers, preferably a single layer. The meaning of configured in this context is that it can be coiled in circumferential direction in the form of a single layer or of multiple layers, preferably a single layer. If the reinforcement layer of the invention is configured as single reinforcement layer of the belt bandage, the pneumatic tire exhibits good ultrahigh-speed functionality, while shrinkage and dimensional stability are improved and flattening effects under load (flatspotting) are reduced. At the same time, the single-layer structure significantly reduces rolling resistance.

When the reinforcement layer described above is used as bead reinforcement in a pneumatic tire, the advantage is that this reinforcement layer exhibits a higher modulus of elasticity and a higher tensile force value for predefined elongation than polyamide reinforcement layers usually used hitherto. The bead reinforcement improves stability of the vehicle in motion, and steering behavior.

Corresponding advantages are also achieved when the reinforcement layer described above is used for the production of other elastomeric products, for example conveyor belts, drive belts, hoses and air-spring bellows.

Further features, advantages and details of the invention will now be explained in more detail with reference to the diagrams, which represent working examples. In the drawings:

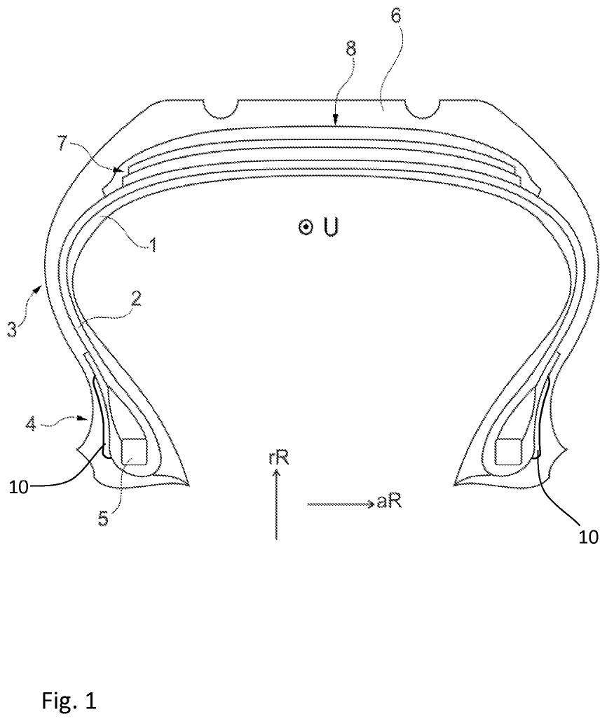

FIG. 1 shows a radial cross section through a pneumatic tire of the invention;

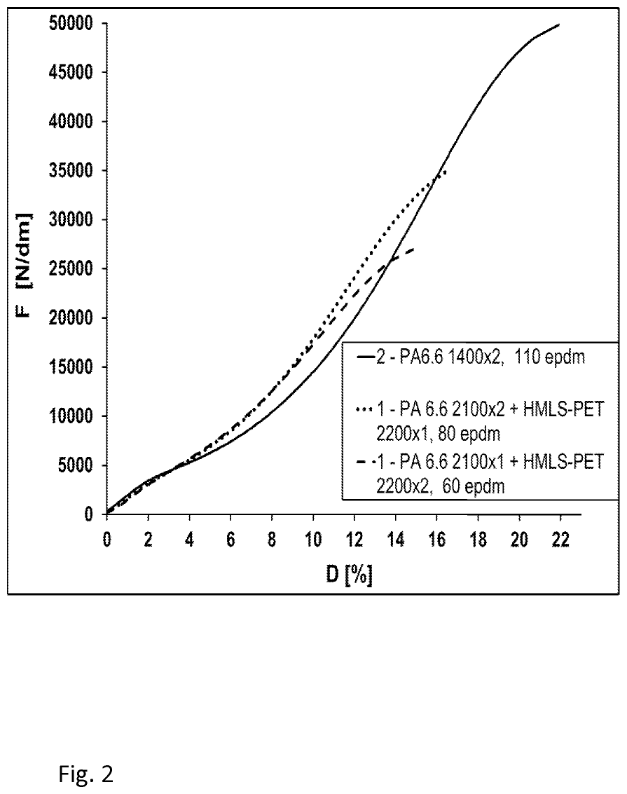

FIG. 2 shows a force/elongation curve of reinforcement layers.

FIG. 1 shows a radial cross section through a pneumatic tire for a car. The essential components of which the depicted pneumatic vehicle tire is composed are a substantially air-impermeable internal layer 1, a carcass 2 which in conventional manner reaches from the region of the crown of the pneumatic vehicle tire by way of the sidewalls 3 into the bead regions 4 and is anchored there by wrapping around tension-resistant bead cores 5, a profiled tread 6 located radially outside the carcass and a belt 7 arranged between the tread 6 and the carcass 2 and comprising two reinforcement layers which is radially covered on the outside by the belt bandage 8, which comprises at least one reinforcement layer. The belt bandage 8 covers the belt edges 9 and comprises reinforcement elements wound parallel in circumferential direction of the pneumatic tire along the axial width and embedded into elastomeric material. The pneumatic tire further comprises a bead reinforcement 10. The bead reinforcement 10 is arranged entirely or to some extent within the bead region 4. The bead reinforcement 10 is positioned axially outside and connected to the carcass 2. The bead reinforcement 10 comprises at least one reinforcement layer which runs around the tire in circular form in the region of the bead.

The tire of the invention can comprise a reinforcement layer, designed in the invention, of the belt bandage 8 and/or a reinforcement layer, designed in the invention, of the bead reinforcement 10. The tire can also be designed without bead reinforcement 10 and only with belt bandage 8 of the invention. It is preferable that each of the components 8, 10 mentioned comprises precisely one reinforcement layer.

If the tire comprises precisely one reinforcement layer of the invention as single reinforcement layer of the belt bandage 8, this tire has particularly good suitability for ultrahigh-speed use, together with low rolling resistance and good dimensional stability.

The reinforcement layer 8, 10 has hybrid cords as reinforcement. Each of the hybrid cords has precisely three yarns, the ends of which have been twisted together to form the hybrid cord. The three yarns are a first yarn made of polyamide, a second yarn made of high-modulus low-shrinkage polyethylene terephthalate (HMLS-PET) and a third yarn. The third yarn is either a first yarn made of polyamide or a second yarn made of HMLS-PET. The linear density of each hybrid cord here is at least 5000 dtex.

The polyamide can be PA 6.6. The linear density of each of the three yarns of the hybrid cord can be 1000 dtex to 3000 dtex, preferably 1000 dtex to 2500 dtex, particularly preferably 1500 dtex to 2200 dtex. The hybrid cords can be arranged with a thread density of 50 epdm to 90 epdm, preferably 60 epdm to 80 epdm, within the reinforcement layer.

The hybrid cords are treated with an adhesive impregnation system, for example an RFL dip.

In a first working example, the hybrid cords have the structure polyamide 6.6 2100×2+HMLS-PET 2200×1, and are arranged with a thread density of 70 epdm to 90 epdm within the reinforcement layer.

In a second working example, the hybrid cords have the structure polyamide 6.6 2100×1+HMLS-PET 2200×2, and are arranged with a thread density of 50 epdm to 70 epdm within the reinforcement layer.

FIG. 2 shows force/elongation curves determined in accordance with ASTM D885 M of reinforcement layers. The horizontal axis shows the elongation D in percent, and the vertical axis shows force F in Newtons per decimeter of reinforcement layer (perpendicularly to the direction in which the reinforcement layer extends).

Force/elongation curves are depicted for the first working example and for the second working example. The dotted line represents the reinforcement layer of the invention with hybrid cords having the structure polyamide 6.6 2100×2+HMLS-PET 2200×1 with a thread density of 80 epdm. The dashed line represents the reinforcement layer of the invention with hybrid cords having the structure polyamide 6.6 2100×1+HMLS-PET 2200×2 with a thread density of 60 epdm. A continuous line moreover, as reference, represents the force/elongation curve of a two-layer structure where each reinforcement layer of the two-layer structure comprises, as reinforcement, cords having the structure PA 6.6 1440×2 with a thread density of 110 epdm. This type of two-layer structure is usual for the belt bandage in ultrahigh-speed use.

It can be seen that, up to an elongation of about 4%, the inventive reinforcement layers of the two working examples exhibit, for the use in the belt bandage of a pneumatic tire, force/elongation behavior that is similarly advantageous to that of the two-layer reference example. Very surprisingly, it can moreover be seen that with increasing elongation the single-layer working examples of the invention actually exhibit an advantageous steeper force/elongation curve than the two-layer reference example. The reinforcement layers of the first working example and of the second working example have excellent suitability for the use in a single-layer belt bandage of a pneumatic tire as shown in FIG. 1.

### LIST OF REFERENCE SIGNS

### Part of the Description

1 Internal layer
2 Carcass
3 Sidewall
4 Bead region
5 Bead core
6 Tread
7 Belt
8 Belt bandage
9 Belt edge
10 Bead reinforcement
aR Axial direction
rR Radial direction
U Circumferential direction

1.-10. (canceled)

11. A reinforcement layer for a belt bandage comprising:
cords as reinforcement which are arranged within the reinforcement layer parallel to one another and are embedded into elastomeric material, where the cords have at least two yarns, where a first yarn of the yarns is made of polyamide and where the ends of all yarns of a cord are twisted together,
wherein;
the cords are hybrid cords,
each of the hybrid cords has precisely three yarns,
the three yarns are composed of the first yarn made of polyamide, a second yarn made of high-modulus low-shrinkage polyethylene terephthalate (HMLS-PET) and a third yarn,
the third yarn is configured as the first yarn or as the second yarn and
the linear density of each hybrid cord is at least 5000 dtex.

12. The reinforcement layer as claimed in claim 11, wherein the first yarn is a yarn made of polyamide 6.6.

13. The reinforcement layer as claimed in claim 11, wherein two yarns of the hybrid cord are configured identically in their material and in their linear density.

14. The reinforcement layer as claimed in claim 11, wherein the linear density of each of the three yarns of the hybrid cord is respectively 1000 dtex to 3000 dtex, preferably 1000 dtex to 2500 dtex, particularly preferably 1500 dtex to 2200 dtex.

15. The reinforcement layer as claimed in claim 11, wherein the hybrid cords are arranged with a thread density of 50 epdm to 90 epdm, preferably 60 epdm to 80 epdm, within the reinforcement layer.

16. The reinforcement layer as claimed in claim 11, wherein the hybrid cords have the structure polyamide 6.6 2100×2+PET 2200×1 and are arranged with a thread density of 70 epdm to 90 epdm within the reinforcement layer.

17. The reinforcement layer as claimed in claim 11, wherein the hybrid cords have the structure polyamide 6.6 2100×1+PET 2200×2 and are arranged with a thread density of 50 epdm to 70 epdm within the reinforcement layer.

18. A pneumatic tire, comprising:
at least one reinforcement layer having cords as reinforcement which are arranged within the at least one reinforcement layer parallel to one another and are embedded into elastomeric material, where the cords have at least two yarns, where a first yarn of the yarns is made of polyamide and where the ends of all yarns of a cord are twisted together,
wherein;
the cords are hybrid cords,
each of the hybrid cords has precisely three yarns,
the three yarns are composed of the first yarn made of polyamide, a second yarn made of high-modulus low-shrinkage polyethylene terephthalate (HMLS-PET) and a third yarn,
the third yarn is configured as the first yarn or as the second yarn; and
the linear density of each hybrid cord is at least 5000 dtex.

19. The pneumatic tire as claimed in claim 18, wherein the at least one reinforcement layer is configured for a belt bandage.

20. The pneumatic tire as claimed in claim 18, wherein the at least one reinforcement layer is configured for a bead reinforcement.

21. The pneumatic tire as claimed in claim 18, wherein the at least one reinforcement layer is configured as single reinforcement layer of a belt bandage.

22. A pneumatic tire, comprising:
a single reinforcement layer of a belt bandage proximate a tread and having a plurality of cords arranged within the single reinforcement layer parallel to one another and embedded into elastomeric material, where the plurality of cords have at least two yarns; and
wherein each of the plurality of cords has precisely a first yarn made of polyamide, a second yarn made of high-modulus low shrinkage polyethylene terephthalate (HMLS-PET) and a third yarn.

23. The pneumatic tire of claim 22, wherein each of the plurality of cords have the structure polyamide 6.6 2100×2+HMLS-PET 2200×1 with a thread density of 80 epdm.

24. The pneumatic tire of claim 22, wherein each of the plurality of cords have the structure polyamide 6.6 2100×1+HMLS-PET 2200×2 with a thread density of 60 epdm.

25. The pneumatic tire of claim 22, wherein the third yarn is configured identical to the second yarn.

26. The pneumatic tire of claim 22, wherein the belt bandage is a single layer.

27. The pneumatic tire of claim 22, wherein the single reinforcement layer is configured at an angle between 0° and 5° to a circumferential direction.

28. The pneumatic tire of claim 27, wherein the single reinforcement layer is coiled in circumferential direction in the form of a single layer to facilitate ultra high speed functionality and mitigate flattening effects.

29. The pneumatic tire of claim 22, further comprising a bead layer having a bead reinforcement layer, wherein the bead reinforcement layer comprises a plurality of cords arranged within the single reinforcement layer parallel to one another and embedded into elastomeric material, where the plurality of cords have at least two yarns;
wherein each of the plurality of cords has precisely a first yarn made of polyamide, a second yarn made of high-modulus low shrinkage polyethylene terephthalate (HMLS-PET) and a third yarn.
